(19) United States
(12) Patent Application Publication
(10) Pub. No.: US 2022/0042828 A1
(43) Pub. Date: Feb. 10, 2022

(54) ROTOR FOR INDUCTIVE ANGULAR DISPLACEMENT SENSOR

(71) Applicant: SAFRAN ELECTRONICS & DEFENSE, Boulogne-Billancourt (FR)

(72) Inventors: Matthieu SCHMITT, MOISSY-CRAMAYEL (FR); Bernard RABRET, MOISSY-CRAMAYEL (FR); Patrick BESSON, MOISSY-CRAMAYEL (FR); Thierry BESSEDE, MOISSY-CRAMAYEL (FR)

(73) Assignee: SAFRAN ELECTRONICS & DEFENSE, Boulogne-Billancourt (FR)

(21) Appl. No.: 17/413,052

(22) PCT Filed: Dec. 19, 2019
(86) PCT No.: PCT/FR2019/053178

§ 371 Date: Jun. 11, 2021

(30) Foreign Application Priority Data
Dec. 19, 2018 (FR) 1873379

(51) Int. Cl. G01D 5/22

(52) U.S. Cl. CPC G01D 5/2291

(57) ABSTRACT

The present invention relates to an unwound rotor (1) for an inductive angular displacement sensor, which rotor is rotatably movable about a first axis (X1) and symmetrical with respect to the first axis (X1), the rotor (1) having: —a central portion (10), —two active portions (20) on either side of the central portion (10) relative to the first axis (X1), each active portion (20) comprising an outer surface (21) and two connecting walls (221, 222) connecting the outer surface (21) to the central portion (10), the rotor (1) being characterised in that in a plane (P) normal to the first axis (X1), each connecting wall (221, 222) forms an angle (a) greater than 45° with a second axis (X2). The invention also describes an inductive angular displacement sensor comprising such a rotor.

### FIELD OF THE INVENTION

The present invention relates to the field of inductive angular displacement sensors.

### PRIOR ART

Inductive angular displacement sensors (RVDT, Rotary Variable Differential Transformer) are generally used to measure the angular displacement of a part with respect to another.

An inductive angular displacement sensor comprises, in known fashion, a rotor and a stator. The stator, of ferromagnetic material, comprises a primary winding and two secondary windings, and delimits a cavity inside of which the rotor is placed. The rotor, of ferromagnetic material, is unwound, (i.e. without a winding) and movable in rotation inside the stator. The rotor is integral with the part, the angular displacement of which is to be measured.

An inductive angular displacement sensor, illustrated schematically in FIG. 1, operates according to the principle of a transformer. The primary winding 31 of the stator 3 is subjected to a current which induces by electromagnetic coupling a magnetic field in the ferromagnetic rotor 100. In turn, this magnetic field induces a voltage in the two secondary windings 32 of the stator 3.

The two secondary windings of the stator are located so that their output voltages are linked to the angle formed between the rotor and the stator by the relation θ=θ0*(U1−U2)/(U1+U2), where θ represents the angle measured by the inductive angular displacement sensor, θ0 represents the sensitivity of the sensor, U1 represents the output voltage of the first secondary winding, and U2 represents the output voltage of the second secondary winding.

The graph of FIG. 2 illustrates the relation between the output voltages U1, U2 of the secondary windings of the stator and the angular displacement of the rotor. The useful angular range, i.e. the angular range over which the angular displacement of the rotor can be measured with acceptable accuracy, corresponds to the range [−θmax; +θmax].

An inductive angular displacement sensor determines the angular displacement of the rotor based on a voltage ratio, and thus dispenses with the faults of the electronics. An inductive angular displacement sensor is therefore, in addition to being low in cost, a very robust device which can operate reliably in difficult environments (extreme temperatures and pressure, humidity, presence of foreign bodies . . . ). Nevertheless, the useful angular range of an inductive angular displacement sensor is limited, the accuracy of the sensor being limited in particular by the leakage flux of the rotor. For an angular displacement not contained in this useful angular range, the measurement accuracy of the sensor is substantially and rapidly degraded, exponentially for example.

As illustrated by way of an example in FIG. 3, a rotor 100 of an inductive angular displacement sensor has, in known fashion, a central portion 110 and two active portions 120 located on either side of the central portion 110 with respect to a first axis X1 of symmetry of the rotor, the rotor 100 being movable in rotation around the axis X1. The rotor 100 is also symmetrical with respect to a second axis X2, comprised in a plane normal to the first axis X1 and passing through the two active portions 120. The active portions 120 are connected to the central portion 110 by the connecting walls 130 forming, in a plane normal to the first axis X1, an angle α′ of 45° with the second axis X2. A rotor of this type allows gaining access to a useful angular range (in which the measurement accuracy is acceptable) typically on the order of +/−36°.

In certain cases, it is necessary to measure the angular displacement over a greater angular range while retaining an acceptable, or even improved measurement accuracy.

A known means for measuring the angular displacement of a rotor over an entire revolution and with high accuracy is a wound rotor resolver. The rotor of a resolver is helically stacked, and its generators are not concentric with the rotor. The rotor is also wound and includes the primary winding, the two secondary windings being located on the stator. The rotor must then be fed, and its winding requires the emplacement of collectors or of a rotating transformer.

The resolve is a more costly and less robust device than an inductive angular displacement sensor. Consequently, the wound rotor resolve is not suited for cases where the angular displacement must be measured in difficult environments, for example in the field of aeronautics, of space or of the military, or for a limited cost.

### DISCLOSURE OF THE INVENTION

One goal of the invention is to propose an inductive angular displacement sensor having an increased useful angular range.

Another goal of the invention is to propose an inductive angular displacement sensor having greater measurement accuracy.

Another goal of the invention is to retain the durability, the low cost and the ease of manufacture of an inductive angular displacement sensor.

To this end, according to a first aspect of the invention, an unwound rotor for an inductive angular displacement sensor is proposed, the rotor being movable in rotation around a first axis and symmetrical with respect to this first axis, the rotor having:
a central portion,
two active portions on either side of the central portion with respect to the first axis, each active portion comprising:
   an outer surface configured to face an inner face of a stator of the inductive angular displacement sensor,
   two connecting walls connecting the outer surface to the central portion, the rotor also having axial symmetry with respect to a second axis comprised in a plane normal to the first axis and passing through the two active portions, the rotor being characterized in that in the normal plane, each connecting wall forms an angle greater than 45° with the second axis.

Certain preferred but non-limiting features of the rotor described above are the following, taken individually or in combination:
each connecting wall forms an angle comprised between 45° and 120° with the second axis,
the outer surface of each active portion is a ring sector and extends over an angular sector of 90°,
the junction between the outer surface and each connecting wall forms a beveled end,
the rotor also comprises two recesses extending on either side of the central portion at each of the junctions with the connecting walls,
in the normal plane, a distance between any point of the central portion and the second axis is less than a distance between each intersection between the outer surface and the connecting walls and the second axis,
a through passage is formed in the central portion and leads into each face of said central portion,
the through passage is centered on the first axis and has a truncated cylinder-of-revolution cross section including two flats facing the second axis,
the through passage is centered on the first axis and has a cylinder-of-revolution cross section.

According to a second aspect, an inductive angular displacement sensor is proposed, comprising a rotor according to the first aspect and a stator, the stator comprising an inner face, facing which the rotor is configured to be placed.

### DESCRIPTION DES FIGURES

Other features, goals and advantages of the invention will be revealed by the description that follows, which is purely illustrative and not limiting, and which must be read with reference to the appended drawings in which:

FIG. 1, already commented on, illustrates schematically an inductive angular displacement sensor according to the prior art.

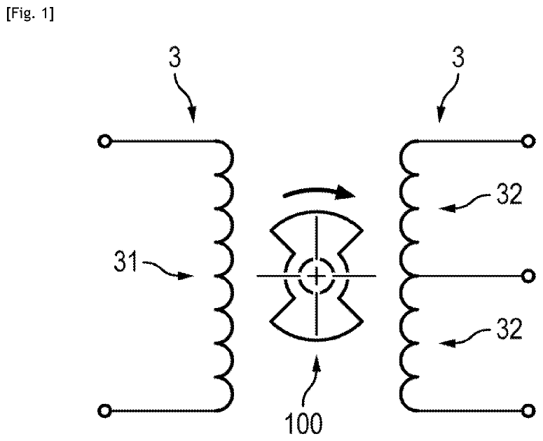

FIG. 2, already commented on, is a graph illustrating the output voltages of secondary windings of an inductive angular displacement sensor according to the prior art as a function of angular displacement.

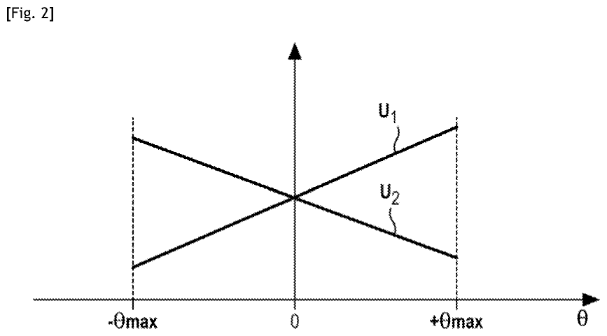

FIG. 3, already commented on, illustrates schematically a transverse section of a rotor for an inductive angular position sensor according to the prior art.

FIG. 4 illustrates schematically a transverse section of an inductive angular displacement sensor according to one embodiment of the invention.

FIG. 5 illustrates schematically a transverse section of a rotor for an inductive angular displacement sensor according to one embodiment of the invention.

FIG. 6 is a graph illustrating the angular displacement measurement accuracy as a function of the angular displacement, for different inductive angular displacement sensors according to the prior art and according to two embodiments of the invention.

FIG. 7 illustrates schematically a transverse section of a portion of an inductive angular displacement sensor according to the prior art.

FIG. 8 illustrates schematically a transverse section of a portion of an inductive angular displacement sensor according to one embodiment of the invention.

FIG. 9 illustrates schematically a transverse section of a portion of an inductive angular displacement sensor according to one embodiment of the invention.

In all the figures, similar elements bear identical reference symbols.

### DETAILED DESCRIPTION OF THE INVENTION

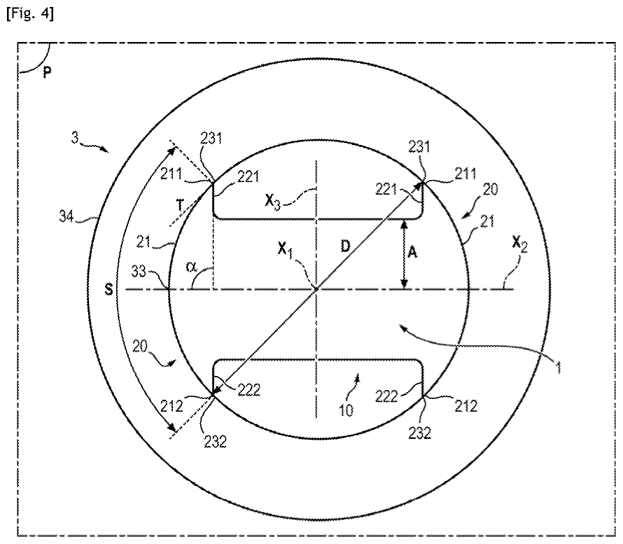

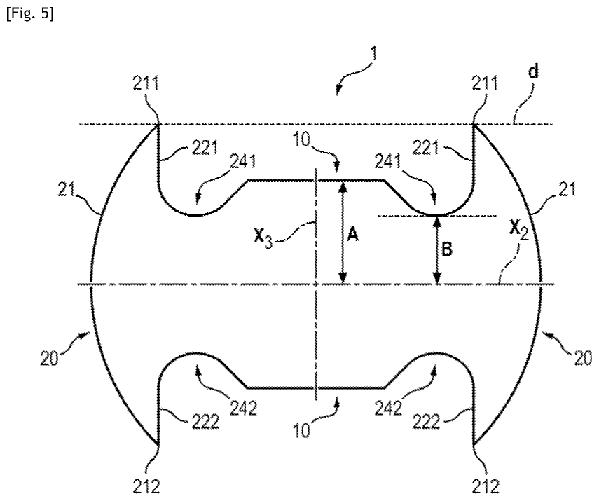

A rotor 1 for an inductive angular displacement sensor, illustrated by way of a non-limiting example in FIGS. 4 and 5, is unwound, movable in rotation around a first axis X1 and symmetrical with respect to this first axis X1. The rotor 1 has:
a central portion 10,
two active portions 20 on either side of the central portion 10 with respect to the first axis X1, each active portion comprising:
   an outer surface 21 configured to face an internal face 33 of the stator 3 of the inductive angular displacement sensor,
   two connecting walls 221, 222 connecting the outer surface 21 to the central portion 10.

The rotor 1 also has axial symmetry with respect to a second axis X2 comprised in a plane P normal to the first axis X1 and passing through the two active portions 20. In the normal plane P, each connecting wall 221, 222 forms an angle α greater than 45° with the second axis X2. In other words, each connecting wall 221, 222 forms an angle α greater than 45° with a plane including the first axis X1 and the second axis X2.

Hereafter in the application, the terms “inner” and “outer” will be used with reference to the first axis X1, such that an inner portion of an element is closer to the first axis X1 than an outer portion of the same element. Moreover, a third axis X3 is defined as being normal to the first axis X1 and to the second axis X2 so that the axes X1, X2 and X3 define together an orthonormal reference frame.

The rotor 1 can for example be manufactured by assembling sheet metal stampings, or be massive and cut from the mass. An existing rotor 1 can be reworked, by electrical discharge machining for example, in order to obtain a rotor 1 profile having an angle α greater than 45° between the connecting wall 221, 222 and the second axis X2. The rotor 1 can be made of a ferromagnetic material for example of NiFe80. The rotor 1 retains its simplicity of production and its cost of manufacture is not significantly increased.

According to a first embodiment, illustrated by way of an example in FIG. 4, each active portion 20 of the rotor 1 has an outer surface 21 and two connecting walls 221, 222. Each outer surface 21 can in particular have a first end 211 and a second end 212 opposite to the first end 211 relative to the second axis X2. A diameter D of the rotor 1 corresponds to a distance between the opposite ends 211, 212 of the outer surfaces 21. A radius R of the rotor 1 corresponds to half of a diameter D of the rotor 1.

Within an active portion 20, a first connecting wall 221 connects the first end 211 of the outer surface 21 to the central portion 10, and a second connecting wall 222 connects the second end 212 of the outer surface 21 to the central portion 10.

Each connecting wall 221, 222 can include a planar main portion and thus include, in the normal plane P, a substantially rectilinear main portion. The angle α between each connecting wall 221, 222 and the second axis X2 then corresponds to the angle between each substantially rectilinear main portion of the connecting wall 221, 222 and the second axis X2.

Such an angle α greater than 45° between the connecting wall 221, 222 and the second axis X2 allows reducing the leakage flux at the junctions between the outer surface 21 and the connecting walls 221, 222. Thus, such a rotor 1 profile allows increasing the useful angular range of the sensor, i.e. the angular range over which the movement of the rotor 1 can be measured with acceptable accuracy. The improvement of the performance of the inductive angular displacement sensor is accomplished without necessitating any other modification of the sensor than that of the rotor 1.

More particularly, the angle α between the connecting wall 221, 222 and the second axis X2 can have a value comprised between 45° and 120°, preferably equal to 90°. For an angle α equal to 90°, the connecting wall 221, 222 is perpendicular to the second axis X2. The manufacture of the rotor 1 is thus facilitated compared with that of a rotor with an angle α different from 90°.

The active portion 20 outer surface 21 can in particular be a ring sector extending over an angular sector S substantially equal to 90°. The rotor 1 being symmetrical with respect to the axis X2, the outer surface 21 extends over an angular sector S/2 of 45° on either side of the second axis X2. In the normal plane P, a tangent T to the first end 211 of the outer surface 21 then forms an angle of 45° with the second axis X2, and an angle between the tangent T and the first connecting wall 221 is less than 90°. In the case where each connecting wall 221, 222 forms and angle α of 90° with the second axis X2, each connecting wall 221, 222 then forms an angle of 45° with the tangent T.

According to one variant embodiment, the junction between the outer surface 21 and each connecting wall 221, 222 can form a beveled end. The rotor 1 can then have two additional walls 231, 232. A first additional wall 231 provides the junction between the first end 211 of the outer surface 21 and the first connecting wall 221. A second additional wall 232 provides the junction between the second end 212 of the outer surface 21 and the second connecting wall 222. These additional walls 231, 232 allow facilitating the machining of the rotor, without substantially deteriorating the useful angular range.

Preferably, each additional wall 231, 232 is substantially planar and forms in the normal plane P and angle of 45° with the second axis X2. Preferably, the dimensions of the additional walls 231, 232 are reduced with respect to the dimensions of the outer surface 21, of the connecting walls 221, 222 and of the central portion 10 of the rotor 1. As a variant, the additional walls 231, 232 can be curved, or be absent when the outer surface 21 is directly connected to the connection walls 221, 222 by sharp angles.

Preferably, when the junction between the outer surface 21 and each connecting wall 221, 222 forms a beveled end, a distance between an outer end of each connecting wall 221, 222 and the first axis X1 is comprised between 90% and 100% of the radius R of the rotor 1.

According to a variant embodiment, in the normal plane P, a distance between any point of the central portion 10 and the second axis X2 is less than a distance between each intersection between the outer surface 21 and the connecting walls 221, 222 and the second axis X2. In particular, a distance between any point of the central portion 10 and the second axis X2 is preferably less than a distance between each end 211, 212 of the outer surface 21 and the second axis X2. A configuration of this type has the effect of limiting the leakage fluxes of the rotor 1 to the stator 3 at the central portion 10 of the rotor 1.

FIG. 5 illustrates an example in which the outer surfaces 21 of the rotor 1 are symmetrical with respect to the third axis X3, in addition to being symmetrical with respect to the second axis X2. Then a straight line d connecting the first ends 211 of each outer surface 21 is parallel to the second axis X2. Any point of the central portion 10, including its outermost point, has a distance to the second axis X2 less than a distance between the straight line d connecting the first ends 211 of each outer surface 21 and the second axis X2.

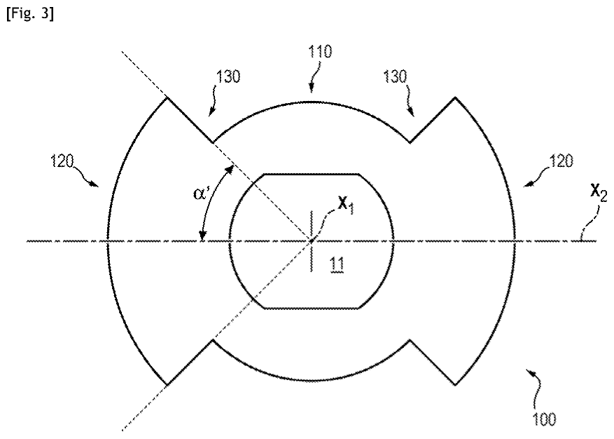

According to a variant embodiment, a through passage 11, illustrated for example for a rotor according to the prior art in FIG. 3, can be formed in the central portion 10 and lead into each face of said central portion 10. The central portion 10 can in particular include two faces located on either side of any normal plane P passing through the rotor 1. Preferably, a shaft integral with the rotor 1 and the angular displacement of which is to be measured is placed inside the through passage 11.

The through passage 11 can be centered on the first axis X1 and have a truncated cylinder-of-revolution cross section including two flats facing the second axis X2. The two flats can in particular be symmetrical and parallel to the second axis X2. The cylindrical sections can be located on either side of the flats and of the third axis X3, and be located symmetrically with respect to the third axis X3. Such a shape of the through passage 11, illustrated by way of an example in FIG. 3, allows retaining the angular displacement measurement carried out by the inductive sensor, even in the case of separation of the rotor 1 from the shaft.

As a variant, the through passage 11 can be centered on the first axis X1 and have a cylinder-of-revolution cross section. The addition of a pin is then necessary to retain the angular displacement measurement carried out by the inductive sensor in case of a separation of the rotor 1 from the shaft.

As a variant, the through passage 11 can have any other shape able to retain the rotor 1 in a secure manner to the part of which the angular displacement is measured.

According to a second embodiment, illustrated by way of an example in FIG. 5, a rotor 1 according to the first embodiment also has two recesses 241, 242. The recesses 241, 242 extend on either side of the central portion 10 at each of the junctions with the connecting walls 221, 222. In other words, the first connecting wall 221 is connected to the central portion 10 by a first recess 241 and the second connecting wall 222 is connected to the central portion 10 by a second recess 242.

Each recess 241, 242 can include, in the normal plane P, a portion substantially shaped like a circular arc. A distance between a center of the circular arc and the second axis X2 can correspond substantially to a distance between the central portion 10 and the second axis X2. Each recess 241, 242 can also include, in a normal plane P, a substantially straight portion. The substantially straight portion can in particular provide the junction between the circular arc portion of the recess 241, 242 and the central portion 10, and can form an angle of approximately 45° with the second axis X2. Such recesses 241, 242 allow limiting the leakage flux at the junctions between the outer surfaces 21 and the connecting walls 221, 222.

A distance B between a recess 241, 242 and the second axis X2 corresponds to a distance B between a point of the recess 241, 242 closest to the second axis X2 and the second axis X2. Preferably, the distance B between the recess 241, 242 and the second axis X2 is less than a distance between a point on the connecting wall 221, 222 closest to the second axis X2 and the second axis X2. Preferably, the distance B between the recess 241, 242 and the second axis X2 is also less than a distance A between a point of the central portion 10 closest to the second axis X2 and the second axis X2. Preferably, the distance B between the recess 241, 242 and the second axis X2 is greater than half the distance A between the point of the central portion 10 closest to the second axis X2 and the second axis X2.

A modification of the profile of the rotor 1 according to the first embodiment or the second embodiment does not substantially modify the saturation of the magnetic materials and their relative permeability, and does not generate magnetic values incompatible with the characteristics of the material used.

An inductive angular displacement sensor, illustrated by way of an example in FIG. 4, comprises a rotor 1 conforming to an embodiment described previously, and a stator 3. The stator 3 comprises an inner face 33, the rotor 1 being configured to be placed facing the inner face 33. The stator 3 comprises several notches 35 able to house the primary winding 31 and the secondary windings 32.

The stator 3 can include an outer face 34 which is substantially a cylinder of revolution around the first axis X1, and its inner face 33 can define a cavity which is substantially a cylinder of revolution around the first axis X1. The dimensions of the inner face 33 of the stator 3 can correspond substantially to those of the outer surfaces 21 of the rotor 1. The outer surfaces 21 of the rotor 1 can be in contact with the inner face 33 of the stator 3, or be separated from the inner face 33 of the stator 3 by a space. The outer surfaces 21 then define cylindrical portions located substantially symmetrically with respect to the third axis X3, each cylindrical portion being symmetrical with respect to the second axis X2. Moreover, in the normal plane P, the angle formed between each connection wall and the second axis X2 is greater than 45°.

Thus only the profile of the rotor 1 is modified and the profile of the outer surfaces 21 is unchanged. The inductive angular displacement sensor therefore retains its ease of manufacture, its low cost and its durability.

Simulations have been carried out to compare the performance of inductive angular displacement sensors as a function of the angular displacement of their rotors, for sensors comprising:
a rotor according to the prior art (Prior art profile),
a rotor 1 according to the first embodiment (Profile 1),
a rotor 1 according to the second embodiment (Profile 2), i.e. corresponding to the profile 1 and also having recesses 241, 242, connecting the central portion 10 and the connecting walls 221, 222.

In this exemplary embodiment, the useful angular range is the angular range for which the measurement accuracy is comprised between +/−0.05°.

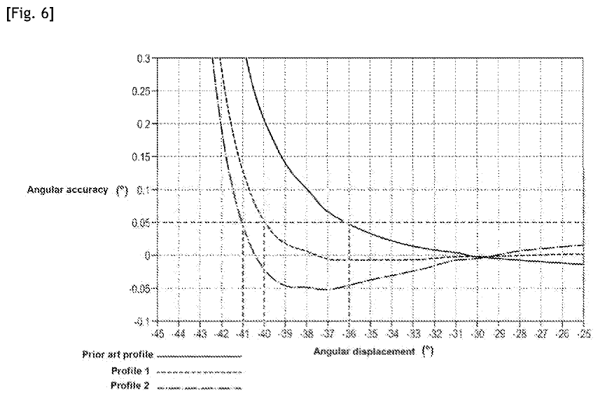

The results of these simulations are illustrated in FIG. 6 and summarized in the following table:

TABLE 1

| | Prior art profile | Profile 1 | Profile 2 |
|---|---|---|---|
| Useful angular range | +/−36° | +/−40° | +/−41° |
| Accuracy at +/−36° | +/−0.048° | +/−0.006° | +/−0.043° |
| Accuracy at +/−40° | +/−0.208° | +/−0.053° | +/−0.05° |
| Accuracy at +/−41° | +/−0.325° | +/−0.13° | +/−0.05° |

Profile 1 leads to a useful angular range improved by +/−4° compared to the prior art profile, as well as an improved measurement accuracy over an angular range of +/−36° compared to the prior art profile.

Profile 2 leads to a useful angular range improved by +/−5° compared to the prior art profile, as well as an improved measurement accuracy over an angular range of +/−36° substantially equivalent to that of the prior art profile.

Profiles 1 and 2 lead to a measurement accuracy (in % of the angle measured) of approximately +/−0.15% over an angular range of +/−40°, where the measurement accuracy of the prior art profile is approximately +/−0.5% over an angular range of +/−40°.

In other words, a rotor profile according to the first embodiment leads to an increased useful angular range, as well as improved measurement accuracy over the useful angular range of a rotor according to the prior art. A rotor profile according to the second embodiment, namely with recesses 241, 242 connecting the central portion 10 and the connecting walls 221, 222, leads to an increased useful angular range compared with the useful angular range of a rotor according to the first embodiment, and to measurement accuracy equivalent to that of a rotor according to the prior art over the useful angular range of a rotor according to the prior art. The rotor profile can therefore be selected depending on the useful angular range and measurement accuracy requirements of the inductive angular displacement sensor.

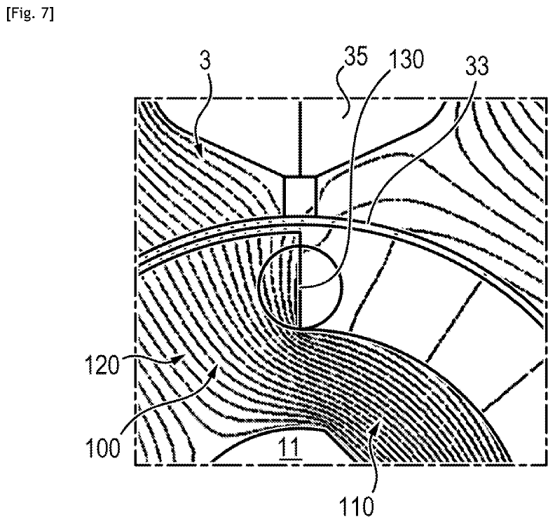

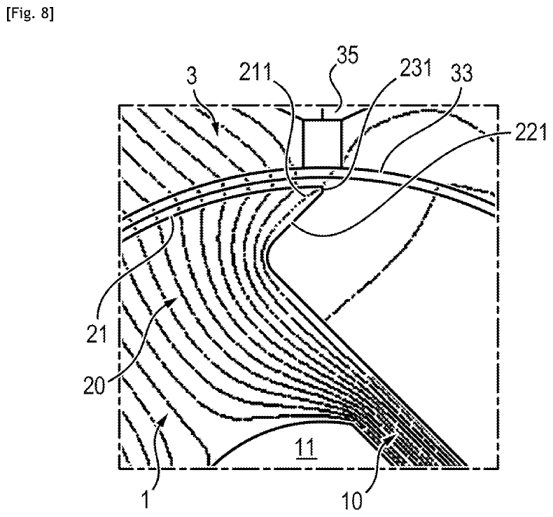

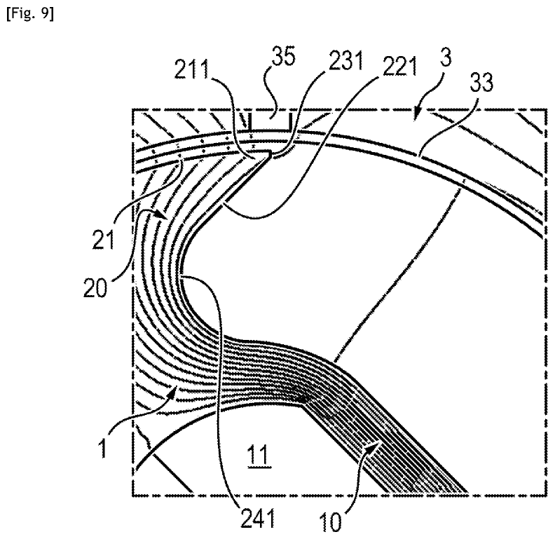

FIGS. 7, 8 and 9 illustrate the influence on the field lines, at a given angular displacement, of the rotor profile. FIG. 7 corresponds to the Prior art profile, FIG. 8 corresponds to Profile 1 and FIG. 9 corresponds to Profile 2. The field lines are shown schematically in these figures.

Leakage field lines can appear at an active portion 20. These leakage field lines do not remain contained in the active portion 20, passing through it from the central portion 10 to its outer surface 21 to join the stator 3. On the contrary, as illustrated in FIG. 7, these leakage field lines lead from the active portion 20 at a corresponding connecting wall 221, 222 to join the stator 3.

Leakage field lines can also appear at a central portion 10. These leakage field lines do not remain contained in the central portion 10, but lead from the central portion 10 substantially perpendicular to it to join the stator 3.

Profiles 1 and 2 allow limiting the number of leakage field lines at the active portions 20 compared to the prior art Profile. Thus, in the example illustrated schematically in FIG. 7, a leakage field line is present for the prior art Profile at the active portion 20. No leakage field line is present for Profile 1 (FIG. 8), or for Profile 2 (FIG. 9).

Profiles 1 and 2 also allow separating the leakage field lines of the active portion 20 and/or spacing them from each other compared to the prior art Profile. Profile 2 allows further separating the leakage field lines of the active portion 20 and spacing them further from each other compared to Profile 1.

Thus, the number of leakage field lines of Profile 1 can be reduced by approximately 60% compared to the prior art Profile, and the number of leakage field lines of Profile 2 can be reduced by approximately 80% compared to the prior art Profile.

Other embodiments can be contemplated and a person skilled in the art can easily modify the embodiments of exemplary embodiments disclosed above, or contemplate others while remaining within the scope of the invention.

1-10. (canceled)

11. An unwound rotor for an inductive angular displacement sensor, the rotor being movable in rotation around a first axis and symmetrical with respect to this first axis, the rotor having:
a central portion,
two active portions on either side of the central portion with respect to the first axis, each active portion comprising:
an outer surface configured to face an inner face of a stator of the inductive angular displacement sensor,
two connecting walls connecting the outer surface to the central portion, the rotor also having axial symmetry with respect to a second axis comprised in a plane normal to the first axis and passing through the two active portions, wherein in the normal plane, each connecting wall forms an angle greater than 45° with the second axis.

12. The rotor according to claim 11, wherein each connecting wall forms an angle comprised between 45° and 120° with the second axis.

13. The rotor according to claim 11, wherein the outer surface of each active portion is a ring sector and extends over an angular sector of 90°.

14. The rotor according to claim 11, wherein a junction between the outer surface and each connecting wall forms a beveled end.

15. The rotor according to claim 14, also comprising two recesses extending on either side of the central portion at each of the junctions with the connecting walls.

16. The rotor according to claim 11, wherein in the normal plane, a distance between any point in the central portion and the second axis is less than a distance between each intersection between the outer surface and the connecting walls and the second axis.

17. The rotor according to claim 11, wherein a through passage is formed in the central portion and leads into each face of said central portion.

18. The rotor according to claim 17, wherein the through passage is centered on the first axis and has a truncated cylinder-of-revolution cross section including two flats facing the second axis.

19. The rotor according to claim 17, wherein the through passage is centered on the first axis and has a cylinder-of-revolution cross section.

20. An inductive angular displacement sensor, the sensor comprising a rotor according to claim 11, and a stator, the stator comprising an inner face, the rotor being configured to be placed facing the inner face of the stator.
